(19) United States
(12) Patent Application Publication
(10) Pub. No.: US 2013/0025216 A1
(43) Pub. Date: Jan. 31, 2013

(54) LAMINATE FLOORING PRODUCT WITH ENHANCED VISUAL AND TRIBOLOGICAL PROPERTIES

(71) Applicants: David P. Reichwein, Elizabethtown, PA (US); Keith A. Pocock, Shanghai (CN)

(72) Inventors: David P. Reichwein, Elizabethtown, PA (US); Keith A. Pocock, Shanghai (CN)

(73) Assignee: GIP INTERNATIONAL, LTD, Special Administrative Region (CN)

(21) Appl. No.: 13/362,581

(22) Filed: Jan. 31, 2012

Related U.S. Application Data
(60) Provisional application No. 61/511,678, filed on Jul. 26, 2011.

(51) Int. Cl. E04B 5/00; B44C 1/22; B29C 59/02; B44C 1/24

(52) U.S. Cl. 52/105; 264/138; 216/49; 216/42; 425/470

(57) ABSTRACT

A laminate floor product resembling a hand-scraped hardwood floor is disclosed. The product includes artificial beveled edges, hand-scraping marks, and chatter marks. The floor product may also include rolled or beveled edges with a decorative and/or scratch resistant paper extending to the peripheral edges.

### CROSS-REFERENCE TO RELATED APPLICATIONS

This application claims priority of U.S. Provisional Patent Application No. 61/511,678, filed Jul. 26, 2011, which is hereby incorporated by reference.

### FIELD OF DISCLOSURE

The present disclosure relates to floor coverings generally, and to laminate flooring specifically.

### BACKGROUND

Hand-scraped or distressed hardwood flooring is a desirable option for new or remodeled structures. Hardwood flooring may not only be aesthetically pleasing, but also have enhanced tribological properties making it resistant to wear and slippage. Hand-scraped flooring may be created by hand cutting and planing boards until they acquire the desired shape. This process is understandably expensive, however, and may produce a cost prohibitive end product. Alternatively, automated mechanical or chemical processes may be used to provide the desired visual and tribological effect. While these processes may be more cost effective than individually hand crafting each plank, the underlying hardwood material may still be too costly for some consumers. As a result, there is a market demand for cost effective flooring with the tribological properties and appearance of hand-scraped or distressed hardwood.

Laminate flooring has proven a cost effective alternative to traditional hardwood floors. Laminate alternatives may be mass produced at limited cost, and may also be easier to install than hardwood. Current laminate flooring may not, however, provide the same desirable traits as distressed hardwood floors. Given the synthetic nature of laminate products, they may appear artificial and could have inferior tribological properties than natural hardwood. Specifically, laminate flooring may be prone to premature wear or inferior surface friction. As a result, consumers looking for an alternative to hardwood may not be satisfied with current laminate products. There is therefore a need for a flooring product with the visual and tribological properties of hand-scraped or distressed hardwood flooring, but at the cost of laminate flooring price.

### SUMMARY

In one embodiment, the present invention provides a laminate flooring product resembling a natural hardwood, hand-scraped floor. The product includes an embossed floor panel having peripheral edges, a bottom surface, and a top surface. After installation the bottom surface may be secured to a floor and the top surface may be exposed to the environment. A plurality of grooves defining artificial edges of an artificial floorboard are embossed on the top surface of the panel. The artificial floorboards may include hand-scraping marks and defect marks to enhance the appearance and tribological properties of the product. Textures may be applied to the surface of the panel to create varying gloss finishes.

A method is also disclosed for forming a laminate flooring product using an embossing plate. An embossing plate is manufactured, having a protruding pattern defining the peripheral edges of a floorboard, hand-scraping marks, and defect marks. This pattern may be pressed into the top surface of a substrate to produce a master panel of the desired laminate product. The edges of the panel may then be trimmed away to produce the final floor panel.

In one embodiment, an embossing plate is provided for forming a laminate flooring product resembling a natural hardwood floor. The plate may include a protruding pattern that, when pressed into the surface of a substrate, defines peripheral edges of an artificial floor board, hand scraping marks, and defect marks. The plate may be manufactured using CNC routing techniques, and may have various textures etched into its surface.

### BRIEF DESCRIPTION OF THE DRAWINGS

FIG. 1 is a front plan view of a laminate floor product formed in accordance with one embodiment of the present invention;

FIG. 2 is an exploded view of an individual plank as shown in FIG. 1;

FIG. 3 is an exploded view of a chatter mark and a hand-scrap mark on an individual plank;

FIG. 4a is a cross-sectional, broken away, view of the laminate flooring product of FIG. 1, as taken along the line 4-4;

FIGS. 4b and 4c are cross-sectional, broken away view of the laminate flooring product of FIG. 4, showing the configurations associated with the edges of the device;

FIG. 5 is a perspective view of an embossing plate formed in accordance with one embodiment of the present invention;

FIG. 6 is a flowchart illustrating the process of creating a laminate flooring product of FIG. 1, using the embossing plate of FIG. 5; and

FIG. 7 is a flowchart illustrating a method for creating the embossing plate of FIG. 5.

### DETAILED DESCRIPTION

This description of preferred embodiments is intended to be read in connection with the accompanying drawings, which are to be considered part of the entire written description of this invention. The drawing figures are not necessarily to scale and certain features of the invention may be shown exaggerated in scale or in somewhat schematic form in the interest of clarity and conciseness. In the description, relative terms such as “horizontal,” “vertical,” “up,” “down,” “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship. When only a single machine is illustrated, the term “machine” shall also be taken to include any collection of machines that individually or jointly execute a set (or multiple sets) of instructions to perform any one or more of the methodologies discussed herein. In the claims, means-plus-function clauses, if used, are intended to cover the structures described, suggested, or rendered obvious by the written description or drawings for performing the recited function, including not only structural equivalents but also equivalent structures. It is noted that references in the specification to “one embodiment”, “an embodiment”, “an alternative embodiment”, etc., mean that the structures or procedures being described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one of ordinary skill in the art would possess the knowledge to effect such feature, structure, or characteristic in connection with other embodiments whether or not explicitly described.

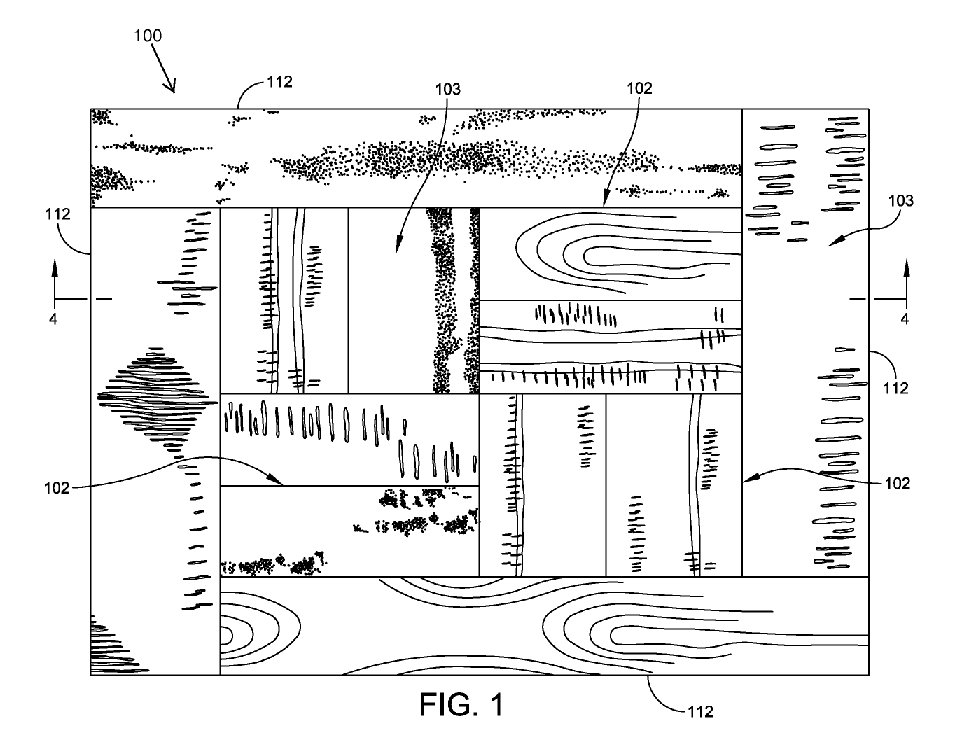

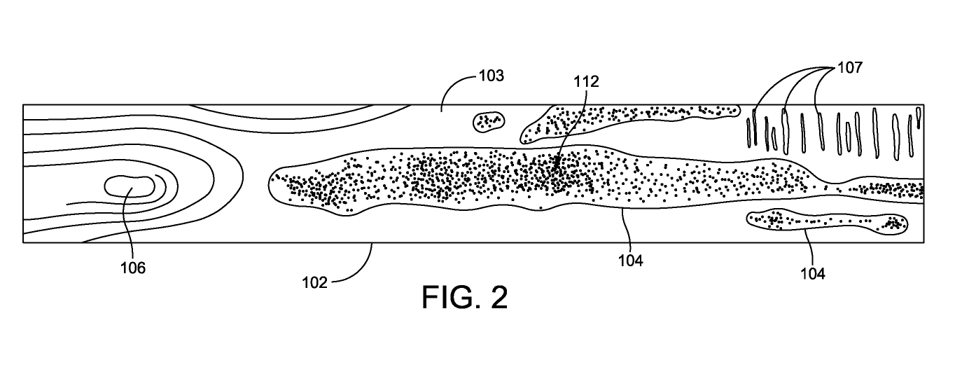

Referring to FIGS. 1, 2, 3, and 4, an embossed laminate floor panel 100 is configured to resemble a natural hand-scraped hard wood floor, and includes embossed edges 102 defining artificial floorboards 103, hand-scraping marks 104 (FIG. 2), and defect marks 106. The surface of floor panel 100 may also include decorative layer 108 and a wear resistant layer 110 which, when combined with the embossed features, provide a durable and slip resistant surface with the visual appearance of a natural hand-scraped hardwood floor.

The embossed designs on the surface of floor panel 100 may include simulated floorboard edges 102, defect marks 106, and hand scraping marks 104. Simulated floorboard edges 102 may be a series of grooves arranged to define a plurality of artificial floorboards 103, and may have a beveled, rounded, or squared appearance. In an alternative embodiment, each floor panel 100 constitutes a single floorboard with embossed edges.

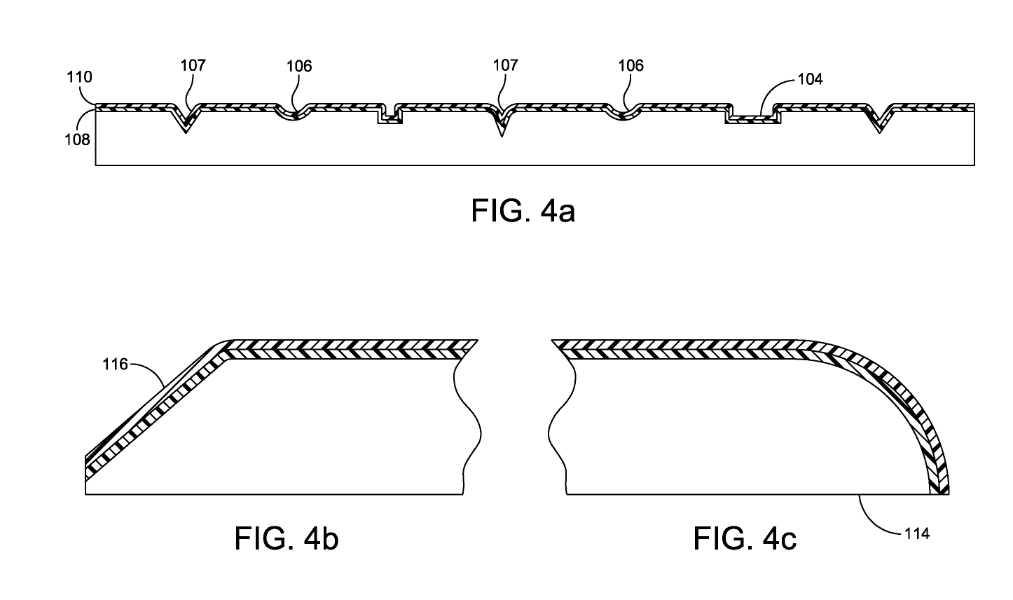

Embossed defect marks 106 (FIG. 4) may resemble chatter marks or natural defects. On natural hardwood flooring, chatter marks may be produced by rotary tools while finishing the floor surface. In an embodiment, chatter marks have a semi-circular or rounded geometry, and occur at substantially regular intervals on the panel surface. Alternatively or additionally, the chatter marks may be linear or randomly defined on the panel surface. Embossed defect marks 106 may also comprise natural defect marks, such as, knots, burls, insect damage, and rot.

Hand-scraping marks 104 may resemble hand-scrapings found on the surface of natural wood flooring. On natural hardwood floors, hand-scraping marks are produced on individual planks by planing and beveling tools used in the manufacturing process. Hand-scraping marks 104 may extend laterally down the surface of artificial floorboards 103. In an embodiment, the hand scraping marks have a rounder geometry than defect marks 106 and embossed edges 102. Alternatively, hand-scraping marks 104 may be embossed along embossed edges 102, creating the impression that edges 102 are hand crafted.

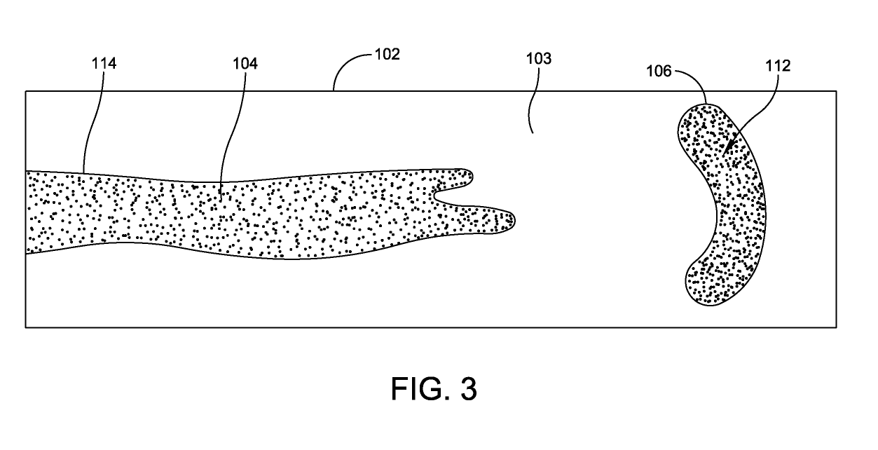

The visual appearance of embossed edges 102, hand-scraping marks 104, and defect marks 106 may be enhanced by applying different gloss finishes. The varying gloss finishes may be applied using textures 112 and 114 (FIG. 3), where the textures diffuse the light reflected from the marks. For example, chatter mark 107 may receive matte texture 112 that diffuses light such that there is a matte or no-gloss finish. Hand-scrape marks 104, in contrast, may receive moderate gloss texture 114 that produces a moderate gloss finish. The surface of artificial floorboards 103 may receive no texture and therefore may have a higher gloss finish. In an embodiment, the textures are micro-texture that are not visible to the naked eye.

Textures applied to a mark or artificial floorboard may not be uniform. For example, a chatter mark may receive both a moderate gloss and a no-gloss texture at different locations of the mark. These varying gloss and texture levels may improve the realistic appearance of the artificial floorboards and enhance the tribological properties, such as wear and surface friction, of the laminate floor product.

Decorative layer 108 and wear resistant layer 110 may cover the surface of floor panel 100. Decorative layer 108 may be formed from a sheet of paper having a natural wood print. The print may comprise an image of finished wood, including printed hand-scraping marks, chatter marks, or natural defects. The printed marks may be aligned over embossed marks 102, 104, and 106 such that the embossed surface provides a three-dimensional texture to the printed images. Wear resistant layer 110 may then be applied over the top of the decorative layer 108 to protect the floor panel. For example, wear resistant layer 110 may protect the panel from scratches, moisture, impact, or any other type of damage. In an embodiment, the wear resistant layer and the decorative layer are integrally formed into a single layer.

Decorative layer 108 and wear resistant layer 110 may extend across the surface of floor panel to peripheral edges 112. In an embodiment, the peripheral edges may comprise rolled edges 114 or pressed bevel edges 116. Extending layers 108 and 110 all the way to edges 112 of the panel may prevent the need for additional edge treatments.

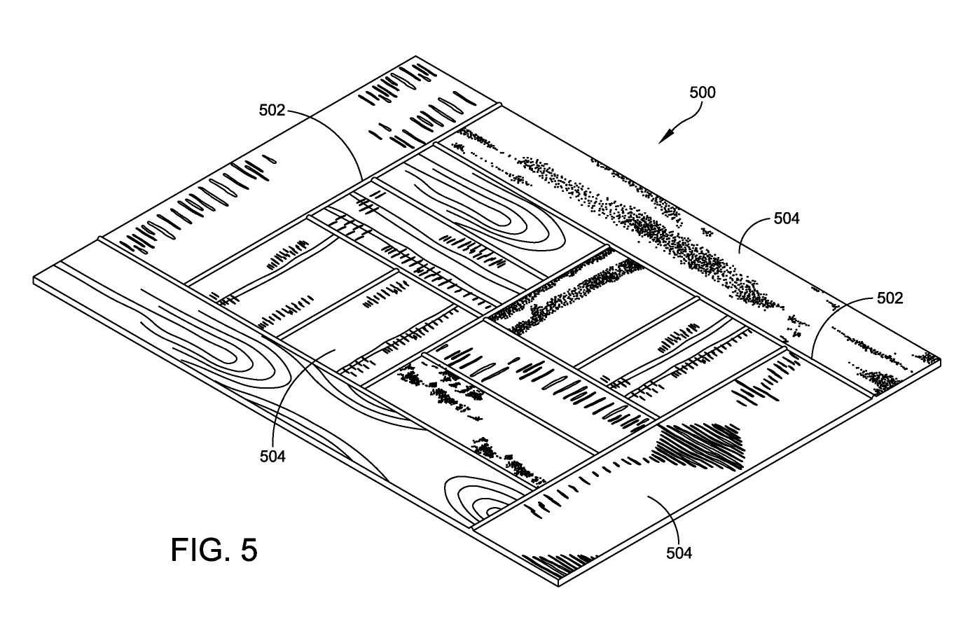

Referring now to FIG. 5, an embossing plate for creating a laminate floor panel is discussed. The created floor panel may be substantially similar to panel 100 as discussed above.

Embossing plate 500 may include pattern 502 protruding from work surface 504. Pattern 502 is configured to be pressed into a substrate to produce embossed marks similar to 102, 104, and 106 discussed above. For example, pattern 502 may define peripheral edges of an artificial floorboard, hand-scraping marks, and defect marks. Different portions of the pattern may protrude different distances from work surface 504 such that embossed marks will have different depths. Additionally or alternatively, portions of the pattern may have different edge geometries, such as angular or circular, thereby allowing embossed marks to also have varying geometries. In an embodiment, pattern 504 comprises textures which produce varying gloss finishes on the final laminate floor panel.

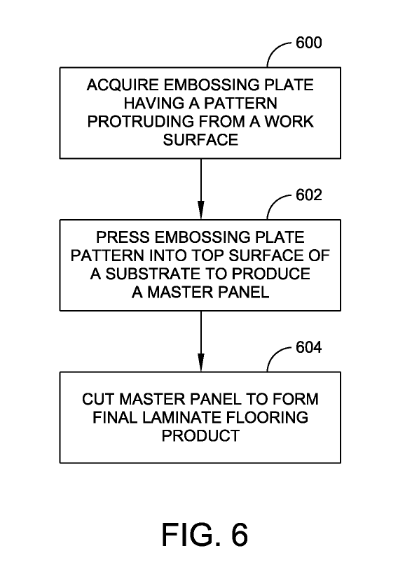

Referring now to FIG. 6, a flow chart for using an embossing plate to create a laminate floor product is discussed. At 600, an embossing plate containing the desired pattern is acquired. The embossing plate may be substantially similar to plate 500 discussed in reference to FIG. 5. The pattern on the plate may define the edges of an artificial floorboard, hand scraping marks, and defect marks.

At 602 the embossing plate is pressed into a top surface of a substrate to produce a master panel. The substrate may comprise a series of layers, including melamine impregnated balancing paper, high density fiberboard, a decorative layer, and a wear resistant layer. The produced master panel may comprise the impression of the embossing plate's pattern, and may include multiple final flooring panels to be separated at 604. In an embodiment, the master panel has a size of approximately 48 inches by 96 inches.

At 604, the produced master panel is cut to produce the final laminate flooring product. If the master panel contains the impression of a single panel, the edges of the master panel may be trimmed to create the final laminate floor panel. If the master panel comprises multiple panel impressions, each of the final panels may be cut from the master. In an embodiment, the edges of the produced final panel may be rolled or beveled to increase panel durability. In any event, the decorative layer and the wear layer extend to, and essentially cover, the edges of the master panel with no or minimum distortion.

Producing a single master panel provides numerous advantages during the manufacturing process. First, it allows the decorative and wear resistant layers to extend to the edges of the floor panel without distorting or moving during the pressing process. As a result, additional edge treatments for the final panel may not be necessary. Producing an individual master panel may further provide enhanced pressure control and registration.

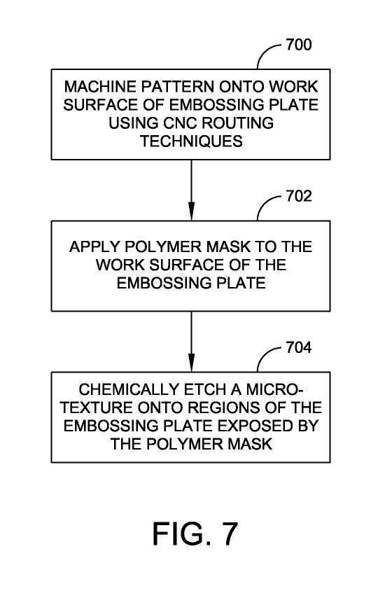

Turning now to FIG. 7, a method for creating an embossing plate is disclosed. At 700 a pattern, such as pattern 502, is routed onto a work surface of the plate. This pattern may be machined into the plate using traditional computer numerical control (“CNC”) routing techniques.

At 702, a polymer mask is applied to the work surface of the plate. The mask may expose portions of the plate to a chemical bath during etching step 704, and may comprise any polymer material used in chemical etching processes. In an embodiment, the polymer mask is sprayed onto the work surface of the embossing plate. Alternatively or additionally, the mask may be heated to a temperature warmer than the work surface prior to its application. In such an embodiment the polymer may cool when it comes into contact with the work surface, thereby increasing its viscosity and adhering to the plate. The polymer mask may also be photo curable material that sets when exposed to light or other radiation. These masking and etching process steps may be repeated to produce additional micro-textures, if desired.

Finally, at 704, the embossing plate is subjected to a chemical etching process. The plate coated with the polymer mask may be placed in a chemical bath which etches regions not protected by the mask. This etching process may create textures, such as micro-textures, on the surface of the embossing plate. These textures may in turn impart variable gloss finishes to the final laminate floor panels. Following the etching process, the plate may be removed from the bath and the polymer mask cleaned from the finished surface.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A laminate flooring product, comprising:
an embossed floor panel having peripheral edges, a bottom surface, and a top surface;
a plurality of grooves embossed into the top surface of the panel, said grooves defining peripheral edges of at least one artificial floorboard; and
a plurality of visual marks embossed into the top surface of the panel, said visual marks detailing at least one hand-scraping mark and at least one defect mark.

2. The laminate flooring product of claim 1, wherein the grooves, hand-scraping mark, and defect mark have different embossing depths and geometries.

3. The laminate flooring product of claim 2, wherein the hand-scraping mark has a rounder geometry than the defect mark and the embossed grooves.

4. The laminate flooring product of claim 1, wherein the defect mark is an embossed chatter mark.

5. The laminate flooring product of claim 1, wherein the grooves and the visual marks have different gloss finishes, wherein the gloss finishes are textures on the top surface of the panel.

6. The laminate flooring product of claim 5, wherein the defect mark has a lower gloss finish that the rest of the panel.

7. The laminate flooring product of claim 5, wherein the textures are micro-textures.

8. The laminate flooring product of claim 1, further comprising a decorative layer substantially covering the top surface and extending to cover the peripheral edges of the panel.

9. The laminate flooring product of claim 1, further comprising a wear resistant layer substantially covering the top surface and extending to cover the peripheral edges of the panel.

10. The laminate flooring product of claim 1, wherein the peripheral edges of the panel are rolled.

11. The laminate flooring product of claim 1, wherein the peripheral edges of the panel are pressed beveled.

12. A method for creating a laminate flooring product, comprising:
acquiring an embossing plate, said embossing plate having a pattern protruding from a work surface, wherein the pattern defines peripheral edges of an artificial floorboard, a hand-scraping mark, and a defect mark;
pressing the embossing plate pattern into a top surface of a substrate to produce a master panel; and
cutting the master panel to form the final laminate flooring product.

13. The method of claim 12, wherein acquiring the embossing plate comprises:
routing the pattern onto the work surface of a plate;
applying a polymer mask to a work surface of the plate; and
etching a micro-texture onto the work surface of the plate, wherein the micro-texture is configured produce differing gloss finishes on distinct regions of the final laminate flooring product.

14. The method of claim 13, wherein the polymer mask is formed from a photo-curable material.

15. The method of claim 13, wherein the polymer mask is sprayed onto the embossing plate while the embossing plate is a cooler temperature than the polymer mask spray.

16. The method of claim 12, wherein the substrate comprises at least one of a decorative layer and a wear resistant layer.

17. The method of claim 12, wherein the master panel is approximately 48 inches by 96 inches.

18. A embossing plate, comprising:
a flooring pattern protruding from a work surface of the embossing plate, said pattern configured to form an embossed floor design on a surface of a substrate, the pattern defining peripheral edges of at least one artificial floorboard, at least one hand-scraping mark on the surface of the artificial floorboard, and at least one defect mark on the surface of the artificial floorboard.

19. The embossing plate of claim 18, wherein the peripheral edges, the hand-scraping mark, and the defect mark have different protrusion geometries.

20. The embossing plate of claim 18, further comprising a micro-texture on the work surface of the embossing plate.
